(19) United States
(12) Patent Application Publication
(10) Pub. No.: US 2007/0052340 A1
(43) Pub. Date: Mar. 8, 2007

(54) Bakery fluorescent lamp

(75) Inventors: Petrus Wilhelmus Vincentius Kop, Roosendaal (NL); Jacobus Johannes Van Loon, Roosendaal (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/573,311

(22) PCT Filed: Sep. 16, 2004
(86) PCT No.: PCT/IB04/51781

§ 371 Date: Mar. 24, 2006

(30) Foreign Application Priority Data
Sep. 29, 2003 (EP) 03103593.4

(51) Int. Cl. H01J 61/44

(52) U.S. Cl. 313/486

(57) ABSTRACT

The invention relates to a fluorescent lamp whereof the fluorescent layer consists of from 1 tot 3 water-dispersible phosphors, such that said lamp has a peak wavelength in each of the red, green and deep-red wavelength regions, wherein deep-red phosphor is derived from a non-activated green, water-dispersible phosphor. The fluorescent layer consists preferably of a red, Eu³⁺ activated phosphor, a green, Tb³⁺ activated phosphor and a deep-red Mn²⁺ activated phosphor, wherein said deep-red Mn²⁺ activated phosphor is a Tb³⁺,Mn²⁺ activated phosphor. The Tb³⁺,Mn²⁺ activated phosphor is preferably a (GdMg)B₅O₁₀:Ce³⁺,Tb³⁺,Mn²⁺ phosphor. Such phosphors can be applied as an aqueous suspension in the production process of a fluorescent lamp.

The invention relates to a fluorescent lamp whereof the fluorescent layer consists of from 1 to 3 phosphors, such that said lamp has a peak wavelength in each of the red, green and deep-red wavelength regions.

Such a lamp is especially suitable for use in bakery stores and butcheries to improve the looks of their merchandise, and is marketed by Applicant as a colour 21 TL(D) lamp. It contains a phosphor blend which consists of a red phosphor, a green phosphor and a deep-red phosphor. The deep-red phosphor of this known lamp is a Mn²⁺ activated phosphor, more specifically Mg₄GeO_{5,5}:Mn, being designated herein as MGM, whereof the peak wavelength is located within the range from 625 to 670 nm inclusive.

The drawback of this known blend is the fact that MGM is not dispersible in water. Therefore the blend of phosphors must be deposited as a suspension in butyl acetate.

It would nevertheless be desirable to coat the lamps with the phosphors as an aqueous suspension, so that the processing can be executed more environmentally friendly.

It has now been found that an aqueous suspension of the phosphors can be prepared when the deep-red phosphor to be used, has the same basic structure as a green, water dispersible phosphor in non-activated state.

The invention therefore relates to a fluorescent lamp whereof the fluorescent layer consists of from 1 tot 3 phosphors, such that said lamp has a peak wavelength in each of the red, green and deep-red wavelength regions, wherein said phosphors are water-dispersible and wherein said deep-red phosphor has the same basic structure as a non-activated green, water-dispersible phosphor.

It was further surprisingly found that the light output of such a lamp is increased with up to 10%, compared with the abovementioned known lamp.

Preferred phosphors to be used in the present fluorescent lamp are claimed in claims 2 to 6 inclusive. With respect to those phosphors the following is observed.

The red phosphor is preferably an Eu³⁺ activated phosphor, more preferably Y₂O₃:Eu³⁺, being designated herein as YOX, whereof the peak wavelength is located within the range from 600 nm to 620 nm inclusive; the green phosphor is preferably a Tb³⁺ activated phosphor, more preferably (GdMg)B5O₁₀:Ce³⁺,Tb³⁺, being designated herein as CBT; (CeGdMg)Al₁₁O₁₉:Tb³⁺, being designated herein as CAT, and LaPO₄:Ce³⁺,Tb³⁺, being designated herein as LAP, which phosphors have a peak wavelength located within the range from 540 to 548 nm inclusive.

The deep-red phosphor is preferably (GdMg)B₅O₁₀:Ce³⁺,Mn²⁺, being designated herein as CBM, and is most preferably further activated to show a peak wavelength in the green wavelength region, such as Tb³⁺,Mn²⁺ activated phosphor, such as (GdMg)B₅O₁₀:Ce³⁺,Tb³⁺,Mn²⁺, being designated herein as CBTM.

It is observed that a fluorescent lamp comprising phosphors such as YOX, CBT and CBTM is as such known from U.S. Pat. No. 6,157,126. According to this reference the blend of phosphors to be used also comprises nevertheless a phosphor producing light at 400 to 460 nm, which means that a blue phosphor is present. There is no suggestion in this known reference that a combination of phosphors can be made without using a blue phosphor, which can be used as an aqueous suspension in the production process of a fluorescent lamp, to obtain a lamp which is especially suitable for butcheries and bakery stores.

Further, it is observed that the phosphor CBTM, thus consisting of (CeGdMg)B₅O₁₀:Tb³⁺,Mn²⁺, is known from U.S. Pat. No. 4,602,188. As has been mentioned in this reference, such a phosphor will supply both the deep-red Mn²⁺ emission and the green Tb³⁺ emission. A combination of this known phosphor with at least one phosphor having red and green emission as proposed in the present invention, is not mentioned nor suggested.

Further, reference is made in U.S. Pat. No. 6,489,716 to EP-0 023 068 describing a fluorescent lamp which employs the phosphor CBT, which phosphor should have comparably good emission characteristics and a higher stability compared with the phosphor CAT (cerium magnesium aluminate:Tb) and LAP (lanthanum phosphate:Ce, Tb). All three phosphors can nevertheless be used as a green phosphor in the present invention.

U.S. Pat. No. 6,489,716 discloses a lamp with a luminescent layer containing three phosphors: as a first phosphor BSCT (gadolinium magnesium borate silicate, activated with cerium and terbium), as a second phosphor YOX, and as a third phosphor SAPE, which is activated with bivalent europium.

A phosphor being activated with bivalent europium is nevertheless a blue fluorescent substance. A combination of phosphors having red, green and deep-red emission as claimed in the present invention is not disclosed in U.S. Pat. No. 6,489,716.

Preferred embodiments of a lamp according to the invention are defined in claims 7 to 10, inclusive.

With respect to the composition of the present blend of phosphors it is observed that when the main ingredient is the red phosphor YOX, the produced lamp will have a high light output and a low red percentage. When CBTM is the main ingredient, this will result in lamps with a lower light output but with a higher red percentage, as will be explained hereafter. It is thus possible to adapt the red percentage of the fluorescent lamp in compliance with the customer's wish, by changing the amount of CBTM.

Because the present blend of phosphors can be deposited on the wall of the lamp as an aqueous suspension, thus as one single layer, the process control will be improved and the logistic being simpler, which will result in a cost price reduction.

The invention also relates to the use of an aqueous suspension of the above indicated three phosphors in the production of a fluorescent lamp.

A preferred embodiment of such a use is defined in claim 7.

The invention will now further be explained by means of the following, non-limiting examples.

### EXAMPLE 1

An aqueous suspension of a phosphor blend (suspension 1) containing 70,5% YOX, 17.6% CBTM and 11.9% CBT was prepared. It was assumed that this phosphor blend should result in a lamp having a colour point with an y value of about 280 to 385. Because the actual y-value was about 10 points lower than anticipated, about 3% b.w. of CBT was added to the suspension.

From 18 W lamps produced by applying these suspensions, as well as a known lamp containing YOX, CBT and MGM as phosphors, applied by using butyl acetate, the relevant parameters of light intensity, x- and y-value of the colour point, as well as the red%, were determined. The results thereof are given in the following Table 1.

TABLE 1

| | coating | | | | |
|---|---|---|---|---|---|
| | weight | Lm | x | y | red % |
| 18 W butyl based | | 1061 | 0.478 | 0.400 | 5.75 |
| suspension 1 | 1.40 g | 1151 | 0.524 | 0.372 | 5.47 |
| suspension 1 + 3.70% CBT | 1.39 g | 1190 | 0.514 | 0.381 | 5.15 |

It appears from Table 1 that the colour point (y), obtained by using the phosphor blend which added CBT, is a desired colour point.

### EXAMPLE 2

Example 1 was repeated, starting from a suspension 2, containing a blend of phosphors consisting of 36.2% YOX, 54.3% CBTM and 9.5% CBT. Again, the actual y-value was about 10 points lower than anticipated, so that about 3% b.w. of CBT was added to the suspension. The parameters of the lamps thus produced, were determined. The results thereof are given in the following Table 2.

TABLE 2

| | coating | | | | |
|---|---|---|---|---|---|
| | weight | Lm | x | y | red % |
| 18 W butyl based | | 1061 | 0.478 | 0.400 | 5.75 |
| suspension 2 | 1.40 g | 956 | 0.512 | 0.370 | 8.81 |
| suspension 2 + 3.24% CBT | 1.37 g | 992 | 0.501 | 0.379 | 8.21 |

It appears from Table 2 that the colour point (y), obtained by using the phosphor blend with some extra added CBT, is a desired colour point.

### EXAMPLE 3

In this example a number of aqueous suspensions were prepared containing a phosphor blend having the compositions as mentioned in the following Table 3. From 18 W fluorescent lamps produced with these phosphors, the light intensity, the colour point parameters and the red % TL were measured. The results thereof are also summarized in the following Table 3 (the results being sorted by red % TL).

TABLE 3

| | | | | Light | Colour point | | |
|---|---|---|---|---|---|---|---|
| Lamp | Phosphor (% b.w.) | | | intensity | (x, y) | | |
| number | YOX | CBTM | CBT | Lumen | x | y | Red % TL |
| 1 | 59 | 15 | 26 | 1318 | 0.476 | 0.411 | 4.20 |
| 2 | 61 | 15 | 24 | 1298 | 0.482 | 0.406 | 4.34 |
| 3 | 62 | 16 | 22 | 1277 | 0.489 | 0.401 | 4.52 |
| 4 | 64 | 16 | 20 | 1255 | 0.495 | 0.395 | 4.69 |
| 5 | 52 | 23 | 25 | 1276 | 0.475 | 0.410 | 4.76 |
| 6 | 66 | 16 | 18 | 1226 | 0.503 | 0.390 | 4.88 |
| 7 | 53 | 23 | 23 | 1260 | 0.481 | 0.405 | 4.93 |
| 8 | 55 | 24 | 21 | 1233 | 0.487 | 0.399 | 5.13 |
| 9 | 45 | 30 | 25 | 1235 | 0.472 | 0.410 | 5.30 |
| 10 | 57 | 25 | 19 | 1205 | 0.494 | 0.394 | 5.37 |
| 11 | 46 | 31 | 23 | 1211 | 0.478 | 0.404 | 5.52 |
| 12 | 58 | 25 | 17 | 1179 | 0.502 | 0.388 | 5.63 |
| 13 | 47 | 32 | 21 | 1192 | 0.484 | 0.399 | 5.77 |
| 14 | 38 | 38 | 24 | 1189 | 0.470 | 0.409 | 5.92 |
| 15 | 49 | 33 | 18 | 1165 | 0.491 | 0.393 | 6.01 |
| 16 | 39 | 39 | 22 | 1162 | 0.476 | 0.404 | 6.16 |
| 17 | 50 | 34 | 16 | 1126 | 0.498 | 0.387 | 6.32 |
| 18 | 30 | 45 | 25 | 1161 | 0.463 | 0.412 | 6.32 |
| 19 | 40 | 40 | 20 | 1130 | 0.483 | 0.398 | 6.45 |
| 20 | 30 | 46 | 23 | 1135 | 0.468 | 0.408 | 6.55 |
| 21 | 41 | 42 | 18 | 1110 | 0.490 | 0.392 | 6.77 |
| 22 | 31 | 47 | 21 | 1108 | 0.475 | 0.401 | 6.92 |
| 23 | 42 | 43 | 15 | 1075 | 0.496 | 0.386 | 7.05 |
| 24 | 32 | 49 | 19 | 1077 | 0.481 | 0.397 | 7.17 |
| 25 | 33 | 50 | 17 | 1053 | 0.487 | 0.390 | 7.54 |

| | | | | | |
|---|---|---|---|---|---|
| 26 | 18 W butyl based | 1061 | 0.478 | 0.400 | 5.75 |
| | phosphor blend | | | | |
| | of YOX, CBT | | | | |
| | and MGM | | | | |

It appears from Table 3 that lamp nr. 13 having a red percentage TL of 5.77%, with x=0.484 and y=0.399 is a lamp which is completely comparable with the known TL(D) 18 W lamp of colour no. 21. The composition of the blend of phosphors used in lamp nr. 13 was 47% b.w. of YOX, 32% b.w. of CBTM and 21% b.w. of CBT. It thus appeared that the phosphor CBTM can be used instead of MGM in the production of a fluorescent lamp; it moreover results in an increase in light intensity of more than 10%.

It is observed that the invention has been explained by means of specific embodiments. It is nevertheless to be understood that these embodiments are merely illustrative and should in no way be construed as limiting the scope of the present invention. Various modifications and variations may be made without departing from the scope and spirit of the invention, the scope of the invention being indicated by the appended claims rather than by the foregoing description.

1. A fluorescent lamp whereof the fluorescent layer consists of from 1 tot 3 phosphors, such that said lamp has a peak wavelength in each of the red, green and deep-red wavelength regions, wherein said phosphors are water-dispersible, and wherein said deep-red phosphor has the same basic structure as a non-activated green, water-dispersible phosphor.

2. A fluorescent lamp as claimed in claim 1, wherein said phosphor having a peak wavelength in the red wavelength region is an Eu³⁺ activated phosphor, preferably Y₂O₃:Eu³⁺.

3. A fluorescent lamp as claimed in claim 1, wherein said phosphor having a peak wavelength in the green wavelength region is a Th³⁺ activated phosphor, preferably selected from the group consisting of (CeGdMg)Al₁₁O₁₉:Tb³⁺; GdMgB₅O₁₀:Ce³⁺,Tb²⁺ and LaPO₄: Ce³⁺,Tb³⁺.

4. A fluorescent lamp as claimed in claim 1, wherein said phosphor having a peak wavelength in the deep-red wavelength region is a Mn²⁺ activated phosphor, preferably (GdMg)B₅O₁₀:Ce²⁺,Mn³.

5. A fluorescent lamp as claimed in claim 4, wherein said phosphor having a peak wavelength in the deep-red wavelength region is further activated to show a peak wavelength in the green wavelength region.

6. A fluorescent lamp as claimed in claim 5, wherein said phosphor is a Tb³⁺,Mn²⁺ activated phosphor, preferably (GdMg)B₅O₁₀:Ce³⁺,Tb³⁺,Mn₂₊.

7. A fluorescent lamp as claimed in claim 1, wherein said phosphors consist of:
from 40-70%, preferably 50% b.w. of a red, Eu³⁺ activated phosphor,
from 10-30%, preferably 17% b.w. of a green Tb³⁺ activated phosphor,
from 10-50%, preferably 35% b.w. of a deep-red Mn²⁺ activated phosphor.

8. A fluorescent lamp as claimed in claim 7, wherein said Mn²⁺ activated phosphor is at least partially replaced by a Tb³⁺,Mn²⁺ activated phosphor.

9. A fluorescent lamp as claimed in claim 1, wherein said lamp has a colour point (x, y) wherein x is a number in the range from 0.475 to 0.495, preferably 0.484, and y is a number in the range from 0.390 to 0.405, preferably 0.399.

10. A fluorescent lamp as claimed in claim 1, wherein said lamp has a red percentage LD in the range from 4-8, preferably 6.4.

11. Use of an aqueous suspension of a red, Eu³⁺ activated phosphor, a green, Tb³⁺ activated phosphor and a deep-red, Tb³⁺,Mn²⁺ activated phosphor in the production of a fluorescent lamp.

12. Use according to claim 11, wherein said aqueous suspension consists of
40-70%, preferably 50% b.w. of Y₂O₃:Eu³⁺,
10-30%, preferably 17% b.w. of(GdMg)B₅O₁₀:Ce³⁺,Tb³⁺, and
10-50%, preferably 35% b.w. of (GdMg)B₅O₁₀:Ce³⁺,Tb³⁺,Mn²⁺.
